(19) United States
(12) Patent Application Publication
(10) Pub. No.: US 2006/0242670 A1
(43) Pub. Date: Oct. 26, 2006

(54) Circuit arrangement and method for digital elevision reception in mobile television receivers

(76) Inventors: Detlef Teichner, KONIGSFELD (DE); Christopher Schmidtmann, Villingen-Schwenningen (DE); Philipp Woehrle, Triberg (DE)

Correspondence Address: BRINKS HOFER GILSON & LIONE, P.O. BOX 10395, CHICAGO, IL, 60610, US

(21) Appl. No.: 10/532,176

(22) PCT Filed: Oct. 24, 2003
(86) PCT No.: PCT/EP03/11850

§ 371 Date: Feb. 3, 2006

(30) Foreign Application Priority Data
Oct. 24, 2002 (DE) 102 49 788.5

(51) Int. Cl. H04N 7/18

(52) U.S. Cl. 725/75; 725/77

(57) ABSTRACT

A digital television system includes a network that connects a display, an operating unit that requests a program or program information, and a television reception unit, a demultiplexer that separates the audio, video and miscellaneous data, a matching stage that matches the audio signal with the video signal, a multiplexer that combines the audio and video signal into one data stream, an evaluation device in communication with the demultiplexer, a memory that stores the miscellaneous data and a controller that manages the miscellaneous data. The memory and the controller form a server unit, and the controller is in communication with the operating unit. The miscellaneous data is transmitted to the network by the controller when recalled from the memory.

### PRIORITY CLAIM

The present patent document is a nationalization of PCT Application Serial No. PCT/EP03/11850, filed on Oct. 24, 2002 filed in the German language. The disclosure of the above application is herein incorporated by reference.

### BACKGROUND OF THE INVENTION

1. Technical Field

The invention relates to a circuit arrangement for digital television reception in mobile television receivers. In particular, the invention relates to a digital television for a vehicle.

2. Related Art

Radio and television broadcasting establishments are broadcasting programs in a digital format. Digital television is known under the designation of Digital Video Broadcasting Television (“DVB-T”). The reception of these DVB-T signals requires special digital receivers since analog receivers are not suitable. Digital broadcasting technology transmits data as a code of zeroes and ones in data packets. At a receiver, the data packets are decoded. With DVB-T, the transmission of the signals occurs terrestrially using antenna masts located on the ground. The signal is transferred according to the standard for digitizing TV signals, Motion Pictures Experts Group, 2^{nd} standard (“MPEG-2”). DVB-T allows information to be transmitted in the form of equal-sized data packets according to a “container concept,” combining video, audio signals and data in one MPEG transport stream. In MPEG-2, the data rate for a television program may be selected between 2 Mbit/s and 15 Mbit/s. Digitally, 3-5 Mbit/s are needed for picture quality. The MPEG coding enables a number of television programs and other data content to be transmitted over one analog transmission channel having 7 or 8 MHz of available bandwidth.

DVB-T uses three modulation methods QPSK, 16 QAM and 64 QAM. Protection against transmission errors may be selected at different levels. DVB-T transmitters operate according to Coded Orthogonal Frequency Division Multiplex (“COFDM”) with information distributed over tightly spaced carrier frequencies. Mobile television reception requires a very high level of data protection to provide a robust signal. As a vehicle with mobile television receiver moves, reflections of the carrier waves from buildings or surrounding terrain may cause multi-path signals that interfere with the desired signal.

### SUMMARY

A digital television system includes a network that communicates audio, video and miscellaneous data signals, a display that receives the signals from the network and displays information from the signals, an operating unit that requests a program or program information through the network, and a television reception unit that processes a digital transmission signal having audio, video and miscellaneous data. The television reception unit may include a television receiver module that receives the digital signal, a demultiplexer that separates the audio, video and miscellaneous data, a matching stage that matches the audio signal with the video signal, a multiplexer that combines the audio and video signal into one data stream for transmission to a network, an evaluation unit in communication with the demultiplexer and receives miscellaneous data from the demultiplexer, a memory that stores the miscellaneous data and a controller that manages the miscellaneous data, where the controller may receive commands and manage the miscellaneous data. The memory and controller may form a server unit. The controller may communicate with the operating unit, the television receiver module, and the demultiplexer. The miscellaneous data may be transmitted to the network by the controller as recalled from the memory.

A digital television reception unit in a mobile television system may include multiple digital television reception modules that receive a plurality of data streams of television signals, a demultiplexer that separates video, audio, and miscellaneous data signals from the data streams, a memory that saves the miscellaneous data according to a specified criteria, an evaluation unit that evaluates the content of the miscellaneous data; a controller that sorts and manages the saved miscellaneous data, where the controller communicates with at least one of the television reception modules; and a network interface for transmitting the audio and video signals into a network and the controller communicates with the network interface.

A method for receiving digital television signals in a mobile television reception system may include receiving multiple digital data streams containing coded and compressed television signals, separating audio, video, and miscellaneous data from each of the digital data streams, evaluating content of the miscellaneous data, saving the miscellaneous data for later retrieval, sorting and managing the saved miscellaneous data, transferring the video and audio data over a network to a display in real-time, and transmitting the miscellaneous data to the display when requested by an operating unit.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of a circuit arrangement for a mobile digital television receiver.

FIG. 2 is a block diagram of the television reception unit in a mobile digital television.

FIG. 3 illustrates acts taken to receive digital television signals in a mobile digital television reception system.

### DETAILED DESCRIPTION OF THE PREFERRED EMBODIMENTS

A mobile digital television may receive signals having audio, video, and data information, or combinations thereof. The mobile digital television may be located on a vehicle, where the vehicle may be a boat, car, train or other conveyance that is used to transport people or cargo. The signals may include miscellaneous data in conjunction with video and/or audio signals. The miscellaneous data may include information that is not directly connected with the picture content displayed on a display screen or associated with the sound. Such information may include videotext data or program guide information that informs a user about channel allocations for programs. The miscellaneous data may include interactive communications for services or the data may be pure data or executable software.

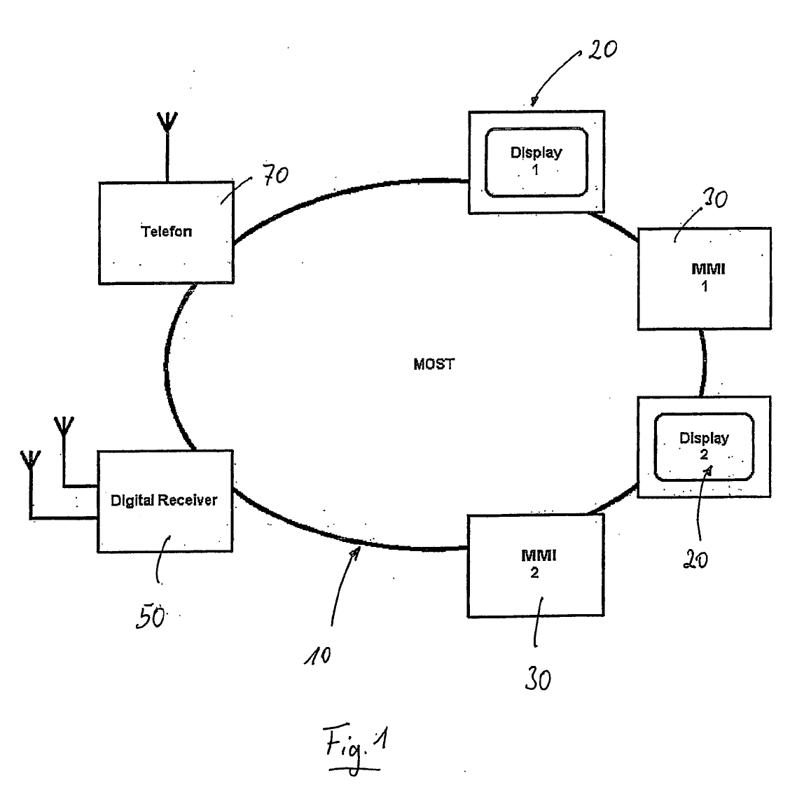

FIG. 1 illustrates a block diagram of a component arrangement for the mobile television system. The arrangement may be a distributed system on an optical bus having a ring-shaped structure. The ring-shaped bus may be a Media Oriented System Transport (“MOST”) bus or network system 110. The components may include a digital television reception unit 150, one or more operating units 130, one or more displays 120, and a wireless telephone system 170. The operating unit 130 may provide an interface between the user and the system. The telephone system 170 provides communications with a local wireless telephone network. The operating unit 130 and the telephone system 170 may be connected to the network 10 through interfaces (not shown).

The mobile digital television system may be installed in a motor vehicle such as a car, truck or sport utility vehicle. Such devices may also be found on boats, buses or any other conveyance of people and/or materials. Two displays 120 may be positioned in the vehicle with one display 120 in the front section of the vehicle between a driver and a front-seat passenger and the second display 120 in a rear section of the vehicle. Two operating units 130 may be included, where one operating unit 130 may be located within the reach of the driver or front-seat passenger and the other operating unit 130 within the reach of the passengers in the rear section or other area of the vehicle. The operating units 130 may be configured with controls that an operator may manipulate to change television channels or to obtain digital information that is transmitted from a television station. The operating unit 130 may be a Man-Machine Interface.

Using the operating units 130, the user may select television programs to be viewed on the display 120 or radio programs to be listened to through an audio device (not shown). The user also may request information that was supplied in the received signal not directly related to the picture or audio content of the program currently received. The organization and management of the data may be carried out exclusively within the digital television reception unit 150. The specific call for a specific subject or data regarding program information within a memory device may be performed by the operating unit 130 when the operating unit 130 sends an appropriate command to a controller unit in the digital television reception unit 150. The controller may in turn find the corresponding information in the memory device and may transmit the information to the network asynchronously for play-back on the display unit 120 or audio device (not shown). The audio device may be a radio or entertainment system that is integral to the vehicle or it may be an audio system that is integral to the display 120.

Within the received digital television signal, apart from the video and audio signals, miscellaneous data or information may be transmitted. The miscellaneous data in the digital signal may be separated from audio and video signals. The miscellaneous data may be selected, sorted, evaluated and saved within the television reception unit 150. The miscellaneous data may include Electronic Program Guide (“EPG”) information. EPG information is a form of an electronic television magazine which may provide the user with information about current or forthcoming programs. The digital data may include other information such as program critiques. The miscellaneous information also may include information that is in a Multimedia Home Platform (“MHP”) format. The user may establish interactive communications with a service facility using the associated controls or input devices on the operating unit 130.

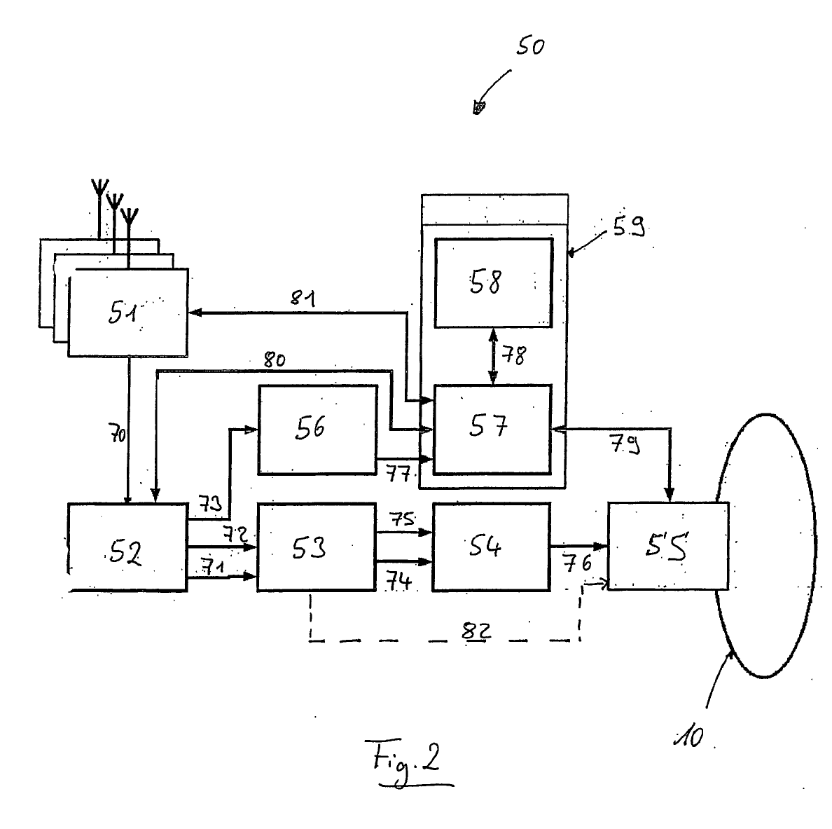

FIG. 2 illustrates a digital television reception unit 150. The television reception unit 150 may have multiple DVB-T television receiver modules 251. The receiver modules 251 may output a data stream to a demultiplexer 252 via a data line 270. The data on data line 270 may be formatted and subdivided into Packetized Elementary Stream (“PES”) blocks. The demultiplexer 252 may be connected to a matching stage 253 with an audio line 271 and video line 272 and to an evaluation unit 256 through data line 273. The matching stage may match the audio signal to the video signal by aligning the time sequence of both signals. In this manner, speech and other audio sound effects may be aligned with the video action. The matching stage 253 may be connected to a multiplexer 254 with an audio line 274 and video line 275 providing the connection. The multiplexer 254 merges the audio and video signal into one signal for transmission to the display or displays 120. The output of the multiplexer 254 is fed to a network interface 255 interfacing with the network 110 and further connects to the displays 120.

The demultiplexer 252 may also be connected to an evaluation unit 256 through data line 273. The evaluation unit may be connected to a controller 257 that controls the demultiplexer 252 through control line 280, the television receiver modules 251 through control line 281, and the network interface 255. The controller 257 also may be connected to a memory 258 through the line 278.

The demultiplexer 252 may output three different signals. The first signal is an audio signal. The audio signal may be digitally formatted in PES blocks and fed to the audio line 271 to the matching stage 253. The second signal may be a video signal. The video signal may be digitally formatted in PES blocks and transmitted on the video line 272 to the matching stage 253 also. The third signal may include digital data. The digital data may be formatted in PES blocks, which may contain information in an EPG or MHP data format, and transmitted on a line 273 to the evaluation unit 256. The evaluation unit 256 may evaluate the content of the miscellaneous data.

The matching stage 253 may be utilized, but may not be absolutely necessary. The matching stage may transcode, re-encode, or convert the data rate of the audio and/or video signals. Whether the signals are encoded or the data rates are converted, the signals may still retain the PES format. The video and audio signals may be transmitted via the lines 274 and 275 to the multiplexer 254. The multiplexer 254 may multiplex the two audio and video signals present on the lines 274 and 275 into a single data stream. The data stream may be transmitted on the line 276 to a network interface 255. The network interface 255 may be a MOST interface or any other interface that connects to an optical or other high-speed data network that is capable of carrying digital video and audio signals.

Alternatively, the matching stage 253 may convert the audio and/or video signal into a pulse code modulation (“PCM”) signal. As shown by the broken line 282 in FIG. 2, the line 282 may transmit the PCM signal directly from the matching stage 253 to the network interface 255 without the use of the multiplexer 254. The interface may be a MOST interface. The audio and video signals are transmitted to the network 110 and to the displays 130 as illustrated in FIG. 1.

The miscellaneous digital data received via line 573 may be evaluated in the evaluator unit and transmitted to the controller 257 over the line 277. The controller 257 may be any microcontroller or microprocessor that is capable of responding to data and forming control signals to control other devices. The controller 257 may respond to software or have embedded commands. The data may be saved in a memory 258 according to a specified criterion. The memory 258 may be a mass storage memory device and may include semiconductor, optical, or magnetic memory units or a combination of these devices. The specified criterion for saving the data in the memory may be held in the controller 257. The controller 257 transmits and receives data to and from the memory 258 over the line bus 278. The controller 257 may sort and manage the data within the memory 258. The controller 257 may also perform security, plausibility and/or completeness checks on the digital data. In combination with the memory 258, the controller 257 may form a server unit 259. The controller 257 may be linked to the interface 255 via a bi-directional line bus 279, to the demultiplexer 252 via the line bus 280, and to the DVB-T receiver modules 251 via the line bus 81.

FIG. 3 illustrates acts taken to receive digital television signals in a mobile digital television reception system. An operator may operate the mobile television system in the following manner. DVB-T digital data streams may be pre-processed, at step 305, at the broadcast location with encoding information to allow processing by a DVB-T receiver. The user may select a desired television program, at step 310, through the operating unit 130 with an appropriate command. The program may be presented to the operator on a display 120 and an associated audio device (not shown). The command for selecting the program may be transmitted from the operating unit 130 through the network 110 and interface 255 in the digital television reception unit 150 and to the controller 257 via the line bus 279. The controller 257 may activate, at step 315, at least one of the DVB-T receiver modules 251 for receiving the user selected program through the digital data streams. The received video and audio signals may be processed accordingly, at step 320, in the demultiplexer 252, matching stage 253 and multiplexer 254. The processed audio/video signal may be transmitted to the interface 255 and into the network 110. The display 120 may receive the audio/video signal from the network 110.

The signal received by the digital television reception module 251 may include miscellaneous digital data that may be assigned to the requested program. The digital data may be separated, also at step 320, from the audio/video signals in the demultiplexer and transmitted to the evaluation unit 256 and the controller 257. If it is determined, at step 325, that there is miscellaneous data present in the digital data streams, the controller 257 may evaluate this miscellaneous data, at step 330. The controller 257 may organize and save the data, at step 335, to the memory 258 for recall by the user at a later time. The audio and/or video data present in the digital data streams may then be transmitted into the network 110, at step 345, for display, at step 350, regardless of whether miscellaneous data is present in the data stream.

The miscellaneous digital data may be repeated cyclically. The controller 257 may check that the miscellaneous data has been saved correctly in the memory 258. The controller 257 may use plausibility and/or completeness checks to determine if data in memory 258 is erroneous or missing. If data is missing or erroneous, then the most currently received data is written to the memory 258.

In addition, the controller 257 may save miscellaneous data to the memory 258 that is associated with other programs received from the plurality of television reception modules 251. The plurality of television reception modules 251 may be tuned to different channels. The controller 257 may obtain and process the miscellaneous data in a background operation, at step 331, separate from the miscellaneous data that corresponds to the processed video/audio signals and written to the memory 258. The controller 257 may transmit the necessary commands to the demultiplexer 252 to transmit the miscellaneous data, associated with the other programs, to the controller 257. After a certain time period, this may result in the memory 258 having a large amount of information at its disposal for all available programs. The user may recall this information quickly for any particular program.

Since the memory 258 may be a mass storage device, a large amount of information may be stored from the miscellaneous data in the television signals. Since there may be a plurality of DVB-T receiver modules, the miscellaneous data received with programs not currently displayed on the display units 120 will be stored in memory 258. Different categories of information that would not normally be available to the user may now be readily available upon a command from the user.

With the memory 258 in the television digital receiver 150, the large amounts of miscellaneous data that is received is not transported across the network 110 to the display units or audio units. Therefore, unless requested by the operator, the data traffic on the network 110 may be limited to the digital video/audio signals that are delivered to the displays 120, thus reducing the data congestion that may otherwise occur. When an operator or user requests information regarding programs, the controller 257 retrieves the information, at step 340, from the memory 258 and makes it available, at step 350, to the appropriate display 120 across the network 110. The data that is saved in the memory 258 may include programming data which starts when certain application software is called upon by the operator.

The system provides the most up to date information to the user for difficult and often changing reception conditions as the vehicle moves through different areas. The mobile television system may ensure that a user has correct and up-to-date information. For example, a current applicable program table may be saved in the memory 258. Due to movement of the vehicle through difficult reception conditions, the transmitted program table may be incomplete or contain erroneous information. The data in memory may be tested for plausibility and/or completeness, and when the data is in error, the data may be substituted, or if missing, the data may be supplemented. To supplement the data, the demultiplexer 252 may be initiated and may make the corresponding data available to the evaluation unit 256 and controller 257. If the controller 257 saved erroneous data previously, upon clean reception of new data, the erroneous data may be overwritten. Therefore, the user may have a current, updated program table.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A digital television system in a vehicle comprising:
a network that communicates audio, video and miscellaneous data signals;
a display that receives the signals from the network and displays information from the signals;
an operating unit that requests a program or program information through the network; and
a television reception unit that processes a digital transmission signal having audio, video and miscellaneous data, the television reception unit further comprising:
a television receiver module configured to receive the digital signal;
a demultiplexer configured to separate the audio, video and miscellaneous data;
a matching stage configured to match the audio signal with the video signal;
a multiplexer configured to combine the audio and video signal into one data stream for transmission to a network;
an evaluation unit in communication with the demultiplexer and configured to receive miscellaneous data from the demultiplexer;
a memory configured to store the miscellaneous data and a controller that manages the miscellaneous data;
a controller configured to receive commands and manage the miscellaneous data,
where the memory and the control unit form a server unit, the control unit is in operable communication with the operating unit, the television receiver module, and the demultiplexer, and the miscellaneous data is transmitted to the network by the controller when recalled from the memory.

2. The digital television system of claim 1 where the network comprises a Media Oriented Systems Transport (MOST) network.

3. The digital television system of claim 1 where the television reception unit further comprises an interface to the network.

4. The digital television system of claim 1 where the data saved in the memory is transmitted asynchronously to the network.

5. The digital television system of claim 1 where the controller is connected to the network via a control bus.

6. The digital television system of claim 1 where a content and an organization of the data saved in the memory are controlled by the controller.

7. The digital television system of claim 6 where the content is determined by a criterion specified by the controller.

8. The digital television system of claim 1 where data is cyclically written to the memory from the controller.

9. The digital television system of claim 1 where the miscellaneous data transmitted to the network from the television reception unit and the miscellaneous data written to the memory unit are selected by the controller.

10. The digital television system of claim 1 where the miscellaneous data written to the memory comprises program data for a television program currently received.

11. The digital television system of claim 10 where the program data saved in the memory comprises one of an Electronic Program Guide and a Multimedia Home Platform.

12. The digital television system of claim 1 where the data in memory is tested for plausibility or completeness, and when the data is in error, the data is substituted, or if missing, the data is supplemented where the demultiplexer is initiated and is configured to make the corresponding data available.

13. The digital television system of claim 1 further comprising a mobile telephone configured to communicate with the network.

14. A digital television reception unit in a mobile television system comprising:
a plurality of digital television reception modules configured to receive a plurality of data streams of television signals;
a demultiplexer configured to separate video, audio, and miscellaneous data signals from the data streams;
an evaluation unit configured to evaluate the content of the miscellaneous data;
a memory that saves the miscellaneous data according to a specified criteria;
a controller configured to sort and manage the saved miscellaneous data, where the controller is configured to communicate with at least one of the plurality of television reception modules; and
a network interface configured to transmit the audio and video signals into a network and the network interface is configured to communicate with the controller.

15. The digital television reception unit of claim 14 where the miscellaneous data comprises program data related to programs other than a program being received.

16. The digital television reception unit of claim 14 where one of the plurality of television reception modules and the controller process miscellaneous data in a background operation for a program other than a program being currently processed and displayed.

17. The digital television reception unit of claim 14 where the operable connection between the controller and the network interface comprises a bi-directional bus that is configured to transmit miscellaneous data into the network.

18. The digital television reception unit of claim 14 where the controller and the memory form a server configured to transmit the miscellaneous data to one of the plurality of displays.

19. The digital television reception unit of claim 14 where the network comprises a ring-shaped Media Oriented Systems Transport network.

20. The digital television reception unit of claim 14 where the network is configured to carry commands from an operating unit operably connected to the network to the controller.

21. The digital television reception unit of claim 20 where the controller is configured to retrieve miscellaneous data from the memory for display.

22. A method for receiving digital television signals in a mobile digital television reception system comprising:
receiving a plurality of digital data streams comprising coded and compressed television signals;
separating audio data, video data, and miscellaneous data from each of the plurality of digital data streams;
evaluating a content of the miscellaneous data;
saving the miscellaneous data according to a specified criterion;
sorting and managing the saved miscellaneous data;
transmitting the audio and video data into the network; and
requesting the saved miscellaneous data for display.

23. The method for receiving digital television signals of claim 22 where transmitting the audio data and the video data into the network further comprises transmitting the audio data and the video data in real-time.

24. The method for receiving digital television signals of claim 22 where evaluating, saving, and requesting the miscellaneous data does not occur in real-time.

25. A digital television reception unit in a mobile television system comprising:
means for receiving a plurality of data streams of digital television signals;
means for separating video data, audio data, and miscellaneous data signals from the plurality of data streams;
means for evaluating the content of the miscellaneous data;
means for saving the miscellaneous data according to a specified criteria; and
means for controlling, sorting, and managing the saved miscellaneous data from the plurality of data streams.

26. The digital television reception unit of claim 25 further comprising means for interfacing to means for networking the video data, audio data and miscellaneous data between the digital television reception unit and a display; and means for responding to requests for the miscellaneous data between an operating unit and the means for controlling.
